(19) United States
(12) Patent Application Publication
(10) Pub. No.: US 2021/0215271 A1
(43) Pub. Date: Jul. 15, 2021

(54) Cast-In-Place Concrete Pipe System

(71) Applicant: Jeffrey Allan Gilbert, Las Vegas, NV (US)

(72) Inventor: Jeffrey Allan Gilbert, Las Vegas, NV (US)

(21) Appl. No.: 16/935,757

(22) Filed: Jul. 22, 2020

Related U.S. Application Data
(60) Provisional application No. 62/961,094, filed on Jan. 14, 2020.

(51) Int. Cl. F16L 1/038; F16L 9/08

(52) U.S. Cl. CPC F16L 1/038; F16L 9/085

(57) ABSTRACT

A cast-in-place concrete pipe system comprising at least one outer barrel, at least one inner barrel, at least one reinforcement dowel used to create a reinforcement cage, at least one reinforcement wall separator, at least one coupling ring, at least one fill port, one or more barrel support stands and a concrete mixture that is poured into the fill port to reside in the space between the outer barrel and the inner barrel. The cast-in-place concrete pipe system is designed to create a single pipe unit which is chemically resistant and configurable to numerous underground pipe, manhole and utility system needs.

### CROSS-REFERENCE TO RELATED APPLICATIONS

The present utility patent application claims priority benefit of the U.S. provisional application for patent Ser. No. 62/961,094 titled “Cast-In-Place Concrete Pipe System” filed on Jan. 14, 2020 under 35 U.S.C. 119(e). The contents of this related provisional application are incorporated herein by reference for all purposes to the extent that such subject matter is not inconsistent herewith or limiting hereof.

### RELATED CO-PENDING U.S. PATENT APPLICATIONS

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### BACKGROUND OF THE INVENTION

### 1. Field of the Invention

The invention relates generally to the field of casting systems for concrete pipe and utility structures. More specifically, the present invention relates to an on-site cast-in-place concrete pipe system for pouring ready mix concrete into pre-formed molds.

### 2. Description of the Related Art

One of the oldest forms of civil engineering and infrastructure construction is the use of underground pipes and conduits. The use of such conduits has been integral to the process of both delivering water into cities and draining storm water and sewage away from them. From the days of ancient Rome to today's modern societies, underground conduit design has evolved from the use of spread-on clay, to the fitting of brick and mortar to today's use of reinforced concrete pipes. Not only have underground conduits evolved in their design, but they have evolved in their usage as well. Today, underground conduits are used for a wider variety of services than simply water and sanitary sewer systems. Underground conduits are used for electrical and telecommunications systems as well.

The current industry standard employs the use of concrete pipes that are pre-cast and delivered to construction sites. Such pipe components are generally made by designing a desired shape and then creating and building large form boxes to serve as molds. The form boxes are then filled with Portland cement or concrete mixtures which can be blended to meet varying industry requirements. The concrete is then allowed to cure for a required length of time. When the concrete cures, the forms are removed and reused. Pipe components are then shipped to a work site where they are placed in an open excavation and fitted with varying conduits. The fitted assemblies are then buried.

Limitations in the current industry standard include the fact that there are very few pre-casting plants in any general area due to factors such as plant size, resource costs and limited demand for such components. Such economic factors generally create regional monopolies which drive prices higher. Additionally, pre-casting concrete pipe components takes time to perform at a plant. In general, it can take up to five days for concrete to set in a form. It also takes up to thirty days for certain types of concrete to cure before the set concrete can be transported to a site. Transportation of cured concrete structures from a regional plant to a construction site generally involves using a crane to load the precast structures on and off a flatbed trailer, where a standard semi-trailer truck then hauls the components to the site. Such transportation of concrete pipe requires some form of heavy equipment to unload and lower said structures into an excavation. This process can not only be time-consuming, but highly expensive due to heavy equipment operation costs. Because of the general weight of concrete, pipe segments are generally limited in size. Moreover, concrete pipe may break during transportation.

An additional limitation with the current industry standard is that concrete pipe structures are susceptible to long-term corrosion from exposure to ionic minerals and gases such as Hydrogen Sulfide. Such corrosion requires concrete pipes to be serviced, repaired and ultimately replaced premature to the expiration of their natural service life. Such servicing generally involves the surfaces being coated with a bituminous material such as tar or asphalt. Other coatings such as epoxies or acrylic paints may be used. Plastic retrofit systems are also available, which involve lining existing structures with plastic components. Such servicing methods, though, are not permanent, are costly and time-consuming to install, and require regular maintenance intervals.

Despite numerous advances and retrofit systems available, though, there still exists a need for a low cost, light weight, on-site form system which provides for a cast-in-place concrete pipe system with the same or greater strength and functionality, meeting or exceeding current industry specifications which can enable a cast-in-place concrete pipe system to be produced and put into service in less time.

### SUMMARY

The present invention fulfils the need for a low cost, light weight, on-site cast-in-place concrete pipe system which creates a concrete pipe system, used underground as integral components of utility systems such as sanitary sewer systems, storm drain systems and electrical and communications systems, with the same or greater strength and functionality, that meets or exceeds current industry specifications, and which is capable of being produced and put into service in less time.

It is an object of the present invention to significantly reduce the time and cost of casting and delivering pre-cast concrete components to remote locations. Such an on-site casting system will eliminate the need for larger plants and the resources required to produce concrete pipe components from such regional locations.

It is another object of the present invention to provide for greater protection of water conduits and sanitary sewer lines from corrosion caused by various reactive compounds in both the fluids carried by the system and by exposure to the surrounding environment. This is achieved through the use of a plastic liner on both the outside and inside of the cast-in-place concrete pipe system.

It is another object of the present invention to provide for greater flow capacity through a concrete pipe system by providing an inner liner which reduces friction. Such a lined concrete pipe system may mitigate debris build up as well.

It is a further object of the present invention to provide a single, structurally stronger and longer lasting concrete pipe system. The use of a casting system which becomes part of the overall structure offers a single, contiguous and stronger structure capable of withstanding greater elemental and environmental exposure.

The system consists of basic components such as, but not limited to, at least one outer barrel, at least one inner barrel, at least one joint dowel, at least one reinforcement wall separator, at least one fill port, one or more barrel support stands, and a concrete mixture that is poured into the said at least one fill port and between the outer and inner barrels. Each component is fabricated to couple with one another through the use of pipe couplers and/or coupler rings. The technology of the on-site concrete pipe casting system operates through the use of manufactured plastic forms which are fabricated at a production facility and delivered to a construction site, assembled and configured on-site, set in place, and are filled with a concrete mixture. The forms, once filled with concrete, may be allowed to cure on-site and in place. The finished structure will be structurally stronger and more resistant to environmental exposure.

The cast-in-place concrete pipe system employs the use of light weight, relatively thin walled plastic forms which are assembled to order and delivered to a construction site. The forms are placed into a prepared excavation site, fitted to underground conduits or pipes, and are then filled with concrete through the use of a ready mix concrete truck, allowed a given time for the concrete to set. The forms may be partially buried prior to the pouring of concrete or after depending on varying requirements. Such a system can serve as a superior alternative to related art which provides a concrete pipe equivalent, which may be superior in strength and function. Furthermore, such as system could produce concrete forms into service in days and not weeks.

### BRIEF DESCRIPTION OF THE DRAWINGS

The invention directed by way of example, and not by way of limitation, in the figures of the accompanying drawings and in which like reference numerals refer to similar elements and in which:

FIG. 1 is an isometric illustration of a section of an exemplary cast-in-place concrete pipe system in accordance with an embodiment of the invention;

FIG. 2 is a side view of an exemplary cast-in-place concrete pipe system in accordance with an embodiment of the invention.

FIG. 3 is a side cross-sectional view of an exemplary cast-in-place concrete pipe system in accordance with an embodiment of the invention;

FIG. 4 is a side cross-sectional view of an exemplary cast-in-place concrete pipe system in accordance with an alternative embodiment of the invention;

FIG. 5 is a side cross-sectional view of an exemplary cast-in-place concrete pipe system in accordance with an alternative embodiment of the invention;

FIG. 6 is an isometric illustration of a reinforcement cage component of an exemplary cast-in-place concrete pipe system in accordance with an embodiment of the invention;

FIG. 7 is a front view of a wall separator ring component of an exemplary cast-in-place concrete pipe system in accordance with an embodiment of the invention;

FIG. 8 is a front cross-sectional view of an exemplary cast-in-place concrete pipe system in accordance with an embodiment of the invention;

FIG. 9 is a side cross-sectional view of a coupling between two segments of an exemplary cast-in-place concrete pipe system in accordance with an embodiment of the invention;

FIG. 10 is a side cross-sectional view of an exemplary cast-in-place concrete pipe system in accordance with an alternative embodiment of the invention;

FIG. 11A is a top view of an exemplary exemplary cast-in-place concrete pipe system in accordance with an alternative embodiment of the invention;

FIG. 11B is a top view of an exemplary exemplary cast-in-place concrete pipe system in accordance with an alternative embodiment of the invention;

FIG. 11C is a top view of an exemplary exemplary cast-in-place concrete pipe system in accordance with an alternative embodiment of the invention; and

FIG. 12 is a flow chart method of providing a cast-in-place concrete pipe system in accordance with an embodiment of the invention.

Unless otherwise indicated illustrations in the figures are not necessarily drawn to scale.

### DETAILED DESCRIPTION OF THE PREFERRED EMBODIMENTS

Terminology used herein is used for the purpose of describing particular embodiments only, and is not intended to limit the scope of the present invention. It must be understood that as used herein and in the appended claims, the singular forms “a,” “an,” and “the” include the plural reference unless the context clearly dictates otherwise. For example, a reference to “an element” is a reference to one or more elements and includes all equivalents known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Language that may be construed to express approximation should be so understood unless the context clearly dictates otherwise.

Unless defined otherwise, all technical and scientific terms used herein have the same meanings as commonly understood by a person of ordinary skill in the art to which this invention belongs. Preferred methods, techniques, devices, and materials are described. But any methods, techniques, devices, or materials similar or equivalent to those described herein may be used in the practice or testing of the present invention. Structures described herein should also be understood to refer to functional equivalents of such structures.

References to “one embodiment,” “one variant,” “an embodiment,” “a variant,” “various embodiments,” “numerous variants,” etc., may indicate that the embodiment(s) of the invention so described may include particular features, structures, or characteristics. However, not every embodiment or variant necessarily includes the particular features, structures, or characteristics. Further, repeated use of the phrase “in one embodiment,” or “in an exemplary embodiment,” or “a variant,” or “another variant,” do not necessarily refer to the same embodiment although they may. A description of an embodiment with several components in communication with each other does not imply that all such components are required. On the contrary, a variety of optional components are described to illustrate the wide variety of possible embodiments and/or variants of the present invention.

As is well known to those skilled in the art, many careful considerations and compromises typically must be made when designing the optimal manufacture or commercial implementation of such a cast-in-place concrete pipe system. A commercial implementation in accordance with the spirit and teachings of the invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art.

The exemplary cast-in-place concrete pipe system will now be described in detail with reference to embodiments thereof as illustrated in the accompanying drawings.

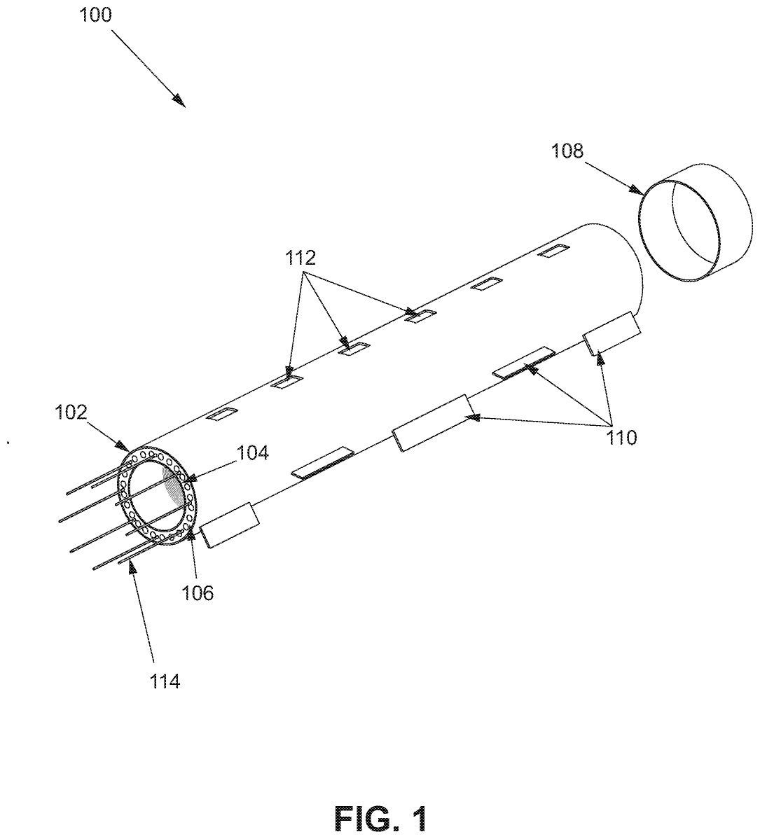

FIG. 1 illustrates an isometric view of an exemplary cast-in-place concrete pipe system in accordance with an embodiment of the invention. The system includes form segments 100 including basic components such as, but not limited to, an assembly including an outer barrel 102, an inner barrel 104, one or more reinforcement wall separator rings 106, one or more pipe coupler rings 108, one or more barrel support stands 110, one or more crown fill ports 112, and one or more joint dowels 114.

In the preferred embodiment of the invention, the outer 102 and inner 104 barrels, the reinforcement wall separator rings 106, and the pipe coupler rings 108 are made of a plastic such as high-density polyethylene (HDPE) of a minimum thickness. Such pipe may include single or multiple walled variants. The lengths of the barrels may vary depending on factors such as, but not limited to, HDPE manufacturing and transportation limits. The diameters of each component, particularly the outer and inner barrels, may also vary depending on factors such as, but not limited to, customer need and flow desirability. The thickness of the components may also vary on factors such as, but not limited to, manufacturing and transportation limits as well. Persons skilled in the art will appreciate that HDPE piping and components may be made to order with varying diameters and pipe thicknesses. The inner and outer barrels for each component are formed through pipe extrusion and molding methods known and understood by persons skilled in the art. In alternative embodiments of the invention, the outer 102 and inner 104 barrels may be made from ribbed high-density polyethylene (HDPE) which may be single or double walled depending on need. In other embodiments of the invention, the pipe components may be made by 3D printing techniques known and appreciated in the art.

Persons skilled in the art will readily appreciate that ribbing of varying thicknesses and sizes may be included in the outer and inner barrels. Such ribbing may be made to order using various extrusion methods known and appreciated in the art. Persons skilled in the art will also understand that ribbing may be formed into the outer diameters of each barrel and are spaced at equal lengths to add additional structural rigidity to each barrel while concrete is being poured into the form. The outer barrel may employ thicker ribbing than the ribbing used by the inner barrel in order provide greater rigidity and support for the outer barrel. Such ribbing may be created by a similar method of plastic pipe extrusion used to create double-walled ribbed plastic pipe.

In various alternate embodiments of the invention, the material used for the outer and inner barrels can be a plastic such as, but limited to, polyvinyl chloride (PVC), polypropylene (PP), or polyvinylidene fluoride (PVDF). Persons skilled in the art will appreciate that additional support mechanisms such as the use of mechanical clamps or friction collars may be used if additional structural support is required until poured concrete cures and the structure is buried.

The forms may be assembled in an excavation or an assembled form can be lowered into an excavation or trench and coupled to other segments. A concrete mixture may then be poured into one or more crown fill ports 112 located at the upper or top end the outer barrel 102. Persons skilled in the art will appreciate that crown fill ports may assume numerous shapes and configurations depending on factors such as, but not limited to, the length of the pipe assembly, the type of concrete used, and the method in which the concrete is poured into the cast-in-place forms (i.e. concrete pump vs. mechanical cement mixer). Crown fill ports may be created through numerous means such as molding, milling or simply cutting apertures into the crown or top end of a horizontally laid pipe. In the preferred method of casting such a concrete pipe assembly, a concrete vibrator is recommended to facilitate the concrete mixture in settling, and to remove any voids in the concrete mixture. Concrete or fill dirt may then be poured over the assembly. The excavation may be filled in either before or after the concrete mixture is poured depending on the particular application. The cast-in-place concrete pipe assembly will be ready for use after a minimum concrete setting time.

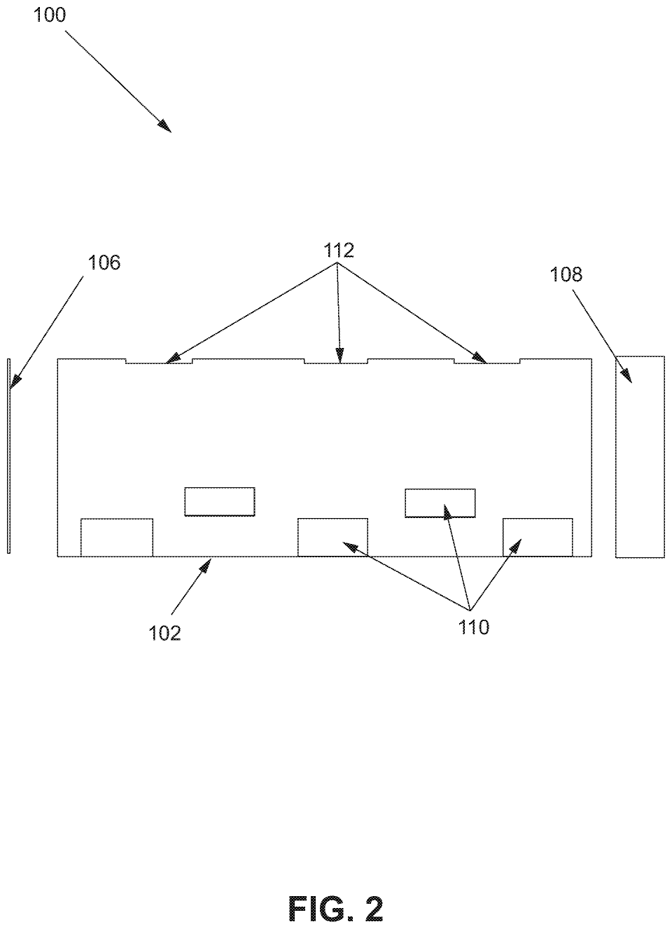

FIG. 2 is a side view of a segment 100 of an exemplary cast-in-place concrete pipe system in accordance with an embodiment of the invention. The system includes basic components such as, but not limited to, an assembly including an outer barrel 102, an inner barrel 104, and one or more reinforcement wall separator rings 106. One or more crown fill ports 112 are located at the upper or top end the outer barrel 102 for a concrete mixture to be poured in. One or more coupling rings 108 are used to join and connect each segment. Persons skilled in the art will readily appreciate that coupling rings can be chemically welded to the outer and inner barrels so as to join pipe segments.

Barrel support stands 110 may be attached to the lower or bottom of the outer barrel. Such a barrel support stand may be used to hold an assembled form upright in order to facilitate the pouring of concrete into the assembled form. Persons skilled in the art will readily appreciate that a barrel support stand may assume numerous shapes and configurations such as, but not limited to, a series of fin-like supports welded to the outer barrel in such a manner so as to hold an assembled form in place in an excavation or trench.

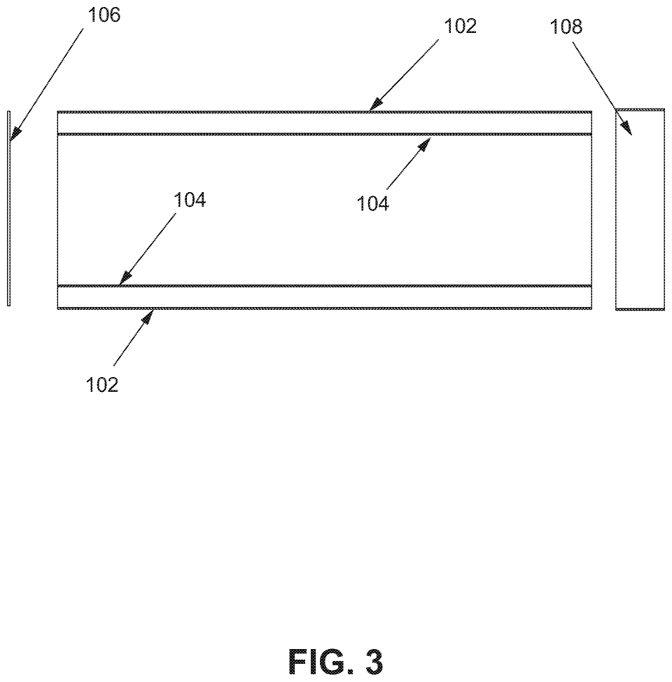

FIG. 3 is a front cross-sectional view of an exemplary cast-in-place concrete pipe system in accordance with an embodiment of the invention. In this view a pipe segment form includes basic components such as, but not limited to, an assembly including an outer barrel 102, an inner barrel 104, one or more reinforcement wall separator rings 106, and one or more pipe coupler rings 108. In an embodiment of the invention, on one end of each segment, a reinforcement wall separator ring 106 is chemically or thermally welded so as to connect the outer barrel 102, the inner barrel 104 and the reinforcement wall separator ring 106. In embodiments of the invention, reinforcement wall separator rings may be placed in multiple locations along the length of the outer and inner barrels. On the opposite end, a pipe coupler ring 108 is used to connect segment forms. The pipe coupler ring has an inner diameter equal or slightly greater than the outer diameter of the outer barrel 102 so as to form a seal between connected segments.

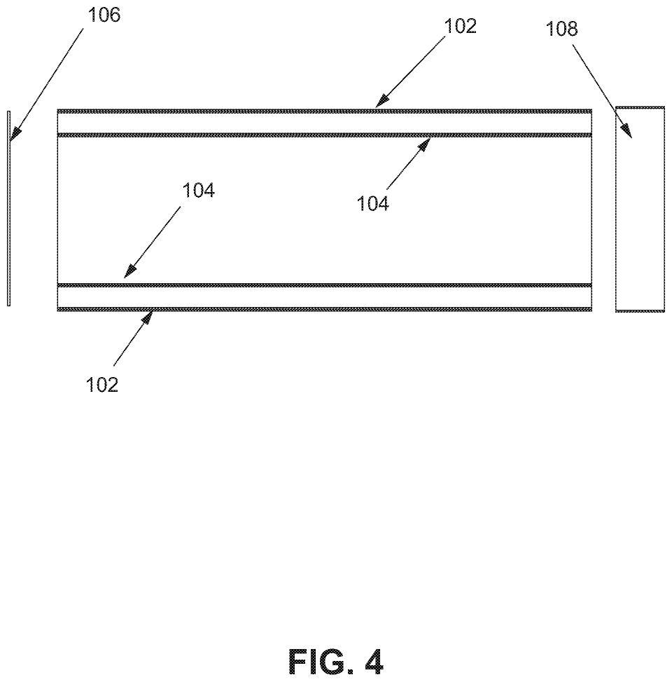

FIG. 4 is a front cross-sectional view of an exemplary cast-in-place concrete pipe system in accordance with an embodiment of the invention. In this view, a pipe segment form includes basic components such as, but not limited to, an assembly including an outer barrel 102, an inner barrel 104, one or more reinforcement wall separator rings 106, and one or more pipe coupler rings 108. Persons having skill in the art will readily appreciate that double-walled plastic may be used to create the outer barrel 102 and the inner barrel 104. In an embodiment of the invention, on one end of each segment, a reinforcement wall separator ring 106 is chemically or thermally welded so as to connect the outer barrel 102, the inner barrel 104 and the reinforcement wall separator ring 106. In embodiments of the invention, reinforcement wall separator rings may be placed in multiple locations along the length of the outer and inner barrels. On the opposite end, a pipe coupler ring 108 is used to connect segment forms. The pipe coupler ring has an inner diameter equal or slightly greater than the outer diameter of the outer barrel 102 so as to form a seal between connected segments.

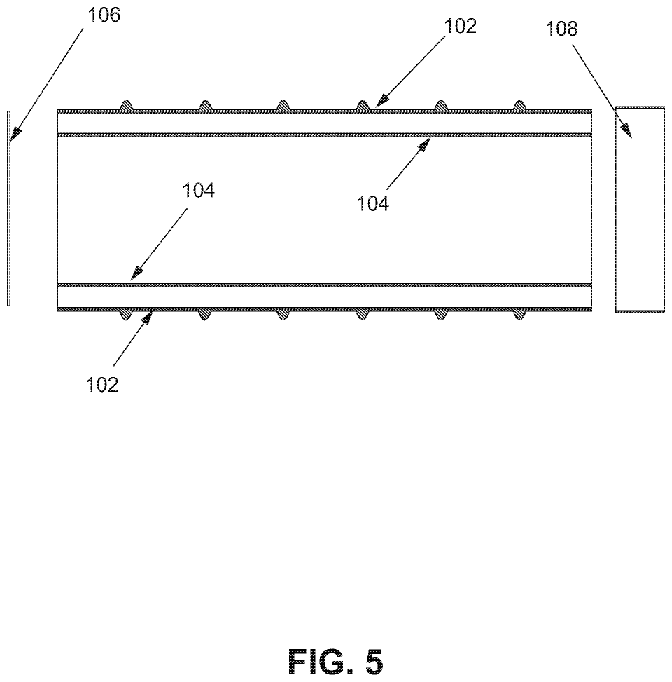

FIG. 5 is a front cross-sectional view of an exemplary cast-in-place concrete pipe system in accordance with an embodiment of the invention. In this view, a pipe segment form includes basic components such as, but not limited to, an assembly including an outer barrel 102, an inner barrel 104, one or more reinforcement wall separator rings 106, and one or more pipe coupler rings 108. Persons having skill in the art will readily appreciate that ribbed double-walled plastic may be used to create the outer barrel 102. Persons having skill in the art will further appreciate that the inner barrel 104 may be made from double walled plastic. Persons skilled in the art will readily appreciate that ribbing of varying thicknesses and sizes may be included in the outer and inner barrels. Such ribbing may be made to order using various extrusion methods known and appreciated in the art. In an embodiment of the invention, on one end of each segment, a reinforcement wall separator ring 106 is chemically or thermally welded so as to connect the outer barrel 102, the inner barrel 104 and the reinforcement wall separator ring 106. In embodiments of the invention, reinforcement wall separator rings may be placed in multiple locations along the length of the outer and inner barrels. On the opposite end, a pipe coupler ring 108 is used to connect segment forms. The pipe coupler ring has an inner diameter equal or slightly greater than the outer diameter of the outer barrel 102 so as to form a seal between connected segments.

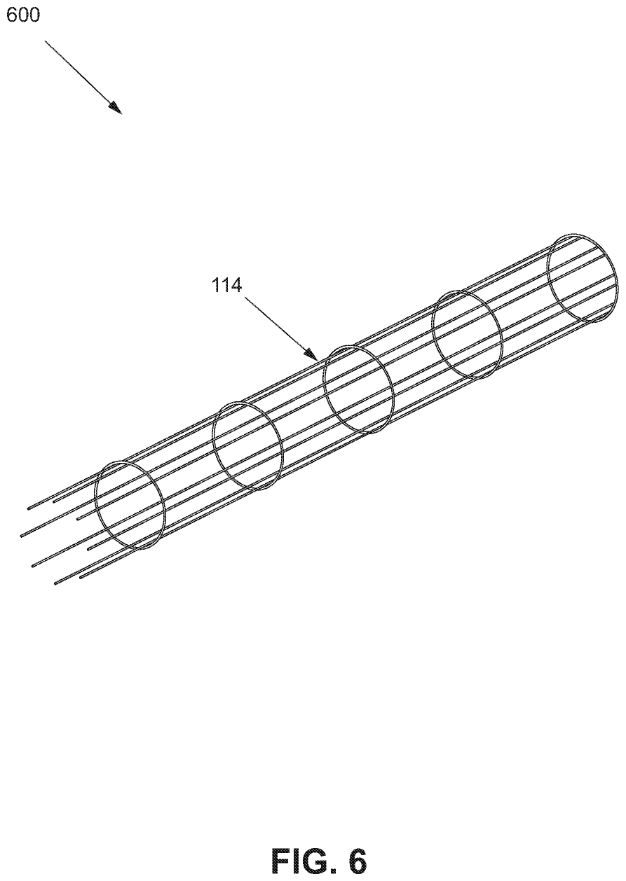

FIG. 6 is an isometric illustration of a reinforcement cage 600 component of an exemplary cast-in-place concrete pipe system in accordance with an embodiment of the invention. In an embodiment of the invention, one or more joint dowels 114 may be shaped, fabricated and connected to form a cylindrical frame. Alternative embodiments of the invention may provide for different shaped reinforcement cages. Persons having skill in the art will readily appreciate that the one or more joint dowels are made of a high tensile strength material such as steel or a composite material. Persons skilled in the art will further appreciate that joint dowels may be joined with other joint dowels through numerous means known and appreciated in the art. Such means include, but are not limited to, wire ties, welds and/or couplers.

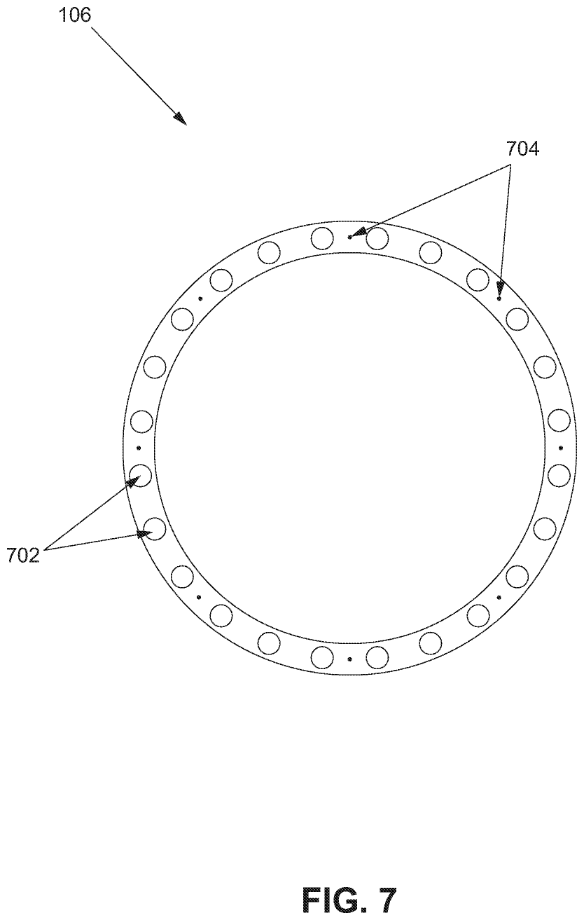

FIG. 7 is a front view of a reinforcement wall separator ring component of an exemplary cast-in-place concrete pipe system in accordance with an embodiment of the invention. Each reinforcement wall separator ring 106 includes a plurality of apertures 702 for poured concrete to surround and ultimately cure forming a contiguous concrete pipe. Persons skilled in the art will readily appreciate that the shape of the reinforcement wall separator rings may be produced by numerous methods known in the art such as, but not limited to, molding or milling. The apertures may assume numerous shapes and configurations so as to provide for the most efficient means of allowing concrete to fill each form segment. Each reinforcement wall separator ring 106 also includes a plurality of dowel apertures 704 which are used for the joint dowels and dowel support saddles. Persons having skill in the art will understand that apertures may be fabricated by numerous means such as, but not limited to, molding, shaping, milling, drilling or stamping. It will become readily apparent that multiple reinforcement wall separator rings may be used throughout the length of each pipe segment.

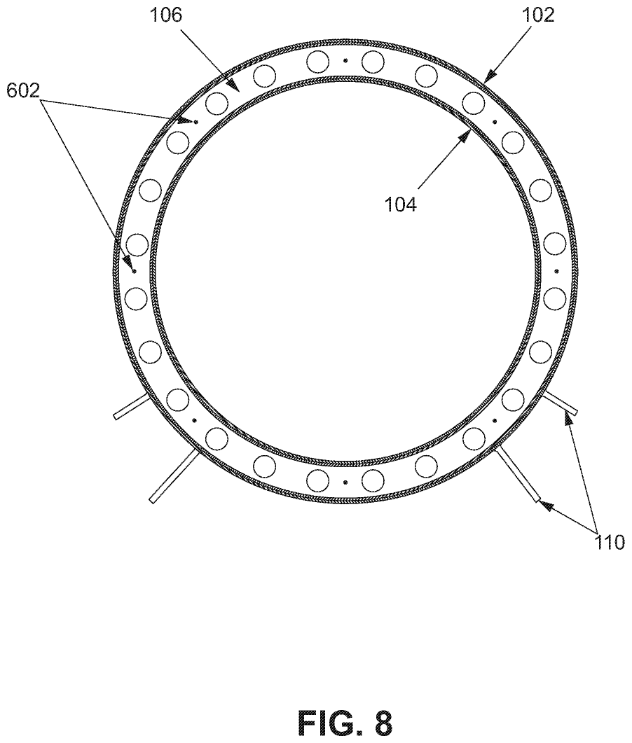

FIG. 8 is a front cross-sectional view of an exemplary cast-in-place concrete pipe system in accordance with an embodiment of the invention. The system includes basic components such as, but not limited to, an assembly including an outer barrel 102, an inner barrel 104, and one or more reinforcement wall separator rings 106. In one embodiment of the invention, the outer barrel 102 and the inner barrel 104 are made from double-walled plastics. Other embodiments of the invention may include single walled variants or ribbed variants. Barrel support stands 110 may be attached to the lower or bottom of the outer barrel. Such a barrel support stand may be used to hold an assembled form in place in order to facilitate the pouring of concrete into the assembled form. Persons skilled in the art will readily appreciate that a barrel support stand may assume numerous shapes and configurations such as, but not limited to, a series of fin-like supports welded to the outer barrel in such a manner so as to hold an assembled form in place in an excavation or trench. Persons skilled in the art will readily appreciate that the shape of the wall separator rings may be produced by numerous methods known in the art such as, but not limited to, molding or milling. The apertures may assume numerous shapes and configurations so as to provide for the most efficient means of allowing concrete to fill each form segment. Each reinforcement wall separator ring 106 also includes a plurality of dowel apertures which are used for a reinforcement cage 600 created with joint dowels and dowel support saddles.

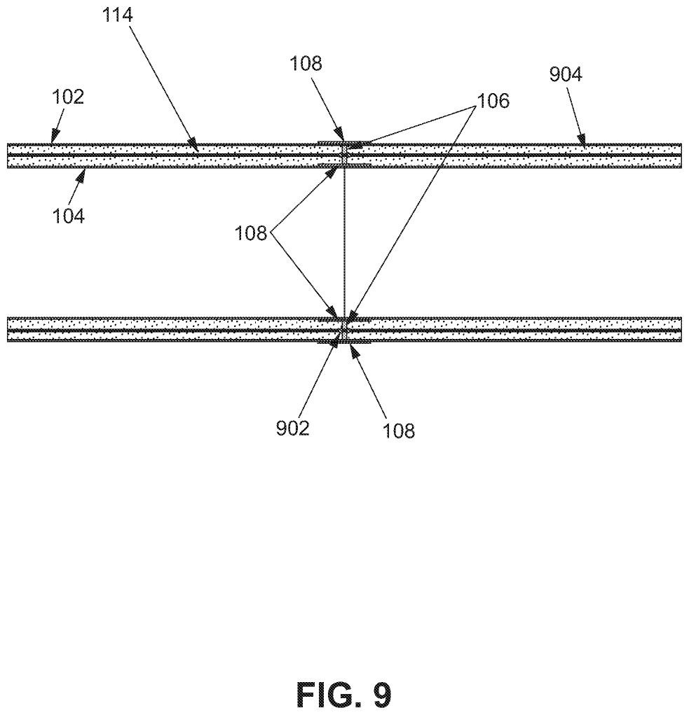

FIG. 9 is a side cross-sectional view of an exemplary cast-in-place concrete pipe system in accordance with an embodiment of the invention. The system includes form segments 100 including basic components such as, but not limited to, an assembly including an outer barrel 102, an inner barrel 104, one or more reinforcement wall separator rings 106, one or more pipe coupler rings 108, one or more dowel support saddles 902, one or more joint dowels 114. Joint dowels or dowel rods are used to provide continuous reinforcement between the form segments where reinforcement cages are discontinuous. In this representation, two segments have been coupled together. A coupling ring 108 has been welded to the ends of the outer barrel 102 of each basic component. A coupling ring 108 is also welded to the ends of the inner barrel 104 of each basic component. Persons having skill in the art will readily appreciate that coupling rings and joint separator rings may be arranged in numerous ways to achieve optimal coupling. In some embodiments, coupling rings are not used to join the inner barrel components. Dowel support saddles 902 are used to hold joint dowels in place. In alternative embodiments, an inner coupling ring or other coupling means may be employed. In the preferred embodiment, an industrial adhesive such as, but not limited to, cyanoacrylate may be used to create such a weld. In other embodiments, a thermal welding means may be used. Persons skilled in the art will understand that there are numerous means for attaching form segments with coupling rings and that the aforementioned are but two examples. In this view, concrete 904 has been poured in the space between the outer barrel 102 and the inner barrel 104.

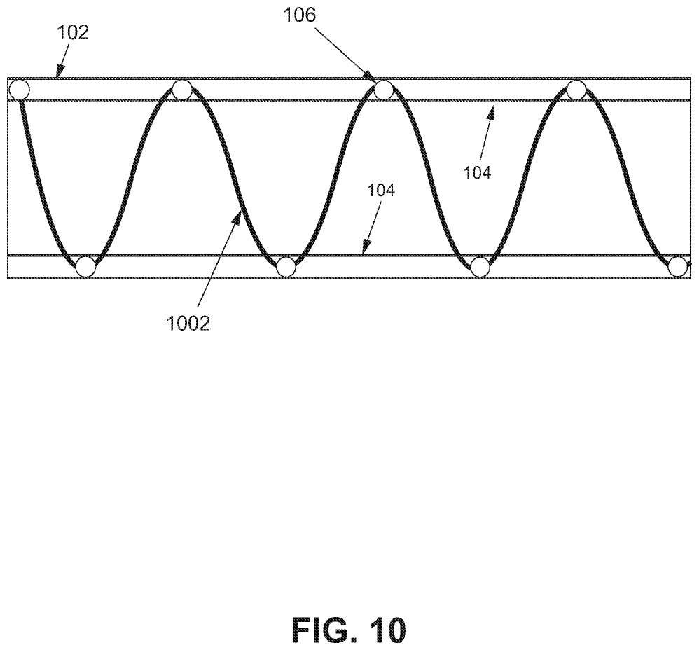

FIG. 10 is a side cross sectional view of an exemplary cast-in-place concrete pipe system in accordance with an alternative embodiment of the invention. A reinforcement system is shown which is incorporated into the cast-in-place concrete pipe system. In this alternative embodiment of the invention, one or more helical shaped reinforcement cages 1002 are used to reinforce concrete poured into assembled forms. The reinforcement cages may be made from a metal or metal alloy such as, but not limited to, steel or cast iron. The reinforcement cages may be held in place through the use of specialized reinforcement wall separator rings 106 centered on the reinforcement cages 1002. In the such an embodiment of the invention, the reinforcement wall separator rings 106 may assume a spherical shape. However, other shapes and configurations of the reinforcement wall separators may be used depending on factors such as pipe thickness and overall length of the pipe segments. The inner barrel and the outer barrel may be uniformly separated using such a series of reinforcement wall separators. The reinforcement wall separators may be further used to secure the outer barrel 102 and the inner barrel 104 by being used as a spacer which is chemically welded to the said outer and inner barrels. In alternative embodiments of the invention, the reinforcement cages may assume different shapes such as, but not limited to, a mesh shape or individual rings. Persons skilled in the art will understand that numerous methods and materials may be used to reinforce poured concrete.

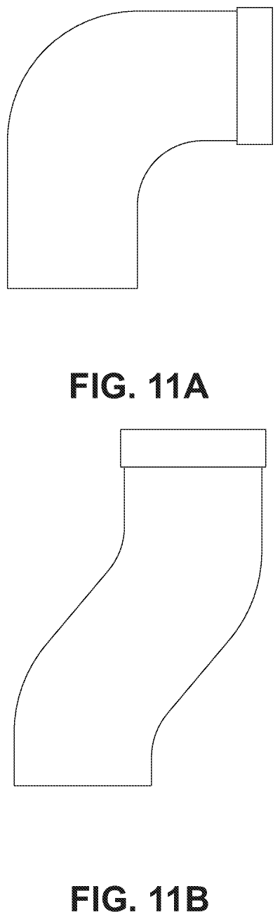

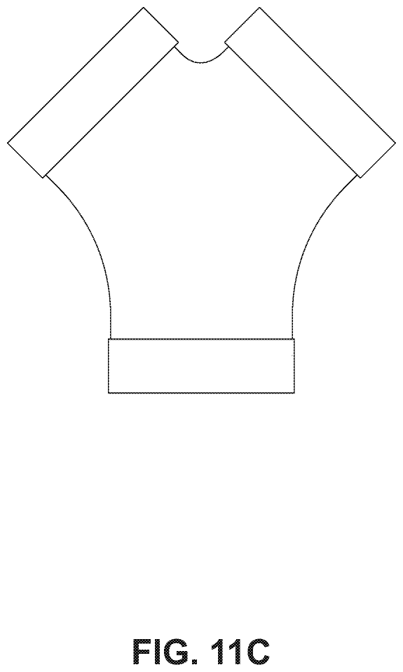

FIG. 11A, FIG. 11B and FIG. 11C each represent a top view of the exemplary cast-in-place concrete pipe system in accordance to alternative embodiments of the invention. Each view represents a pipe segment which may allow for different types of connections and/or changes in direction of the flow of the cast-in-place concrete pipe system. FIG. 11C represents a split pipe segment which may be readily prepared. Persons having skill in the art will readily appreciate that numerous shapes and configurations can be achieved through basic shaping techniques such as, but not limited to, heating pipe segments to shape forms. Similar methods for coupling segments and pouring and setting concrete into alternative forms are used. Such shapes and configurations can allow for a near infinite number of combinations and configurations. Persons having skill in the art will further appreciate that such forms may be created to configure with existing infrastructure such as, but not limited to, concrete pipes and manhole assemblies. The use of plastic forms allows for easy configuration of segments which can simply be prepared on site or can be manufactured at a central facility.

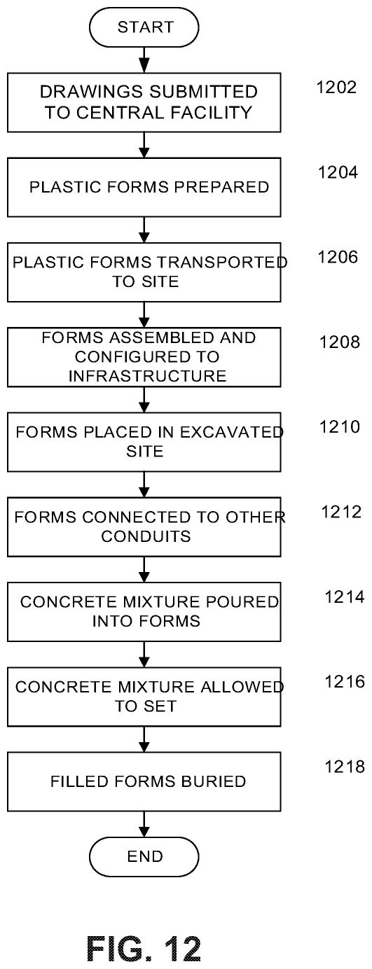

FIG. 12 illustrates a flow chart method of providing a cast-in-place concrete pipe system in accordance with an embodiment of the invention. Such a flow chart method is capable of being implemented across a wide variety of applications including, but not limited to, manhole fittings, sanitary sewer pipes, aqueducts, utility conduits, and concrete structures. Persons skilled in the art will appreciate that in some alternative implementations, the functions noted in the block diagram may occur out of the order noted in the figures. For example, two blocks shown in succession may, in fact, be executed substantially concurrently, or the blocks may sometimes be executed in the reverse order, depending upon the functionality involved.

The exemplary cast-in-place concrete pipe system requires plans to be submitted to a central facility 1202. Such plans include, but are not limited to, pipe dimensions, whether reinforcing bars or wires are required, and types of conduits which may or may not be connected to the concrete pipe assembly. The forms are then prepared in the facility 1204. Preparation of the forms involves the welding of the outer and inner barrels together using either chemical or thermal welding methods, employing the use of additional stiffener rings, threading reinforcing bars or wires through apertures in the stiffener rings, and specially preparing parts for the components.

The prepared plastic forms are then transported to an excavation site 1206 where the components are assembled and configured 1208 (e.g. holes cut and gaskets inserted for connecting to manholes and existing sanitary sewer conduits) to couple with the infrastructure for which the cast-in-place concrete pipe system's plans were submitted in step 1202. Alternatively, the plastic forms may be assembled and configured at the central facility. The configured forms are then placed in the excavation 1210, positioned to the desired flow angle, and connected to whatever conduits and manhole components that are to be connected to the cast-in-place concrete pipe system 1212.

When the cast-in-place concrete pipe system has been fully assembled and connected to the conduits, a concrete mixture may be poured into the form 1214. More specifically, a concrete mixture is poured into the space between the outer barrel and the inner barrel. The concrete is allowed to set 1216, and the filled form is then completely buried 1218. A concrete vibrator may be used to remove air bubbles and facilitate setting of the poured concrete. Alternatively, the form may be partially buried to provide additional support before a concrete mixture is poured in the form.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Having fully described at least one embodiment of the cast-in-place concrete pipe system, other equivalent or alternative methods of implementing the cast-in-place concrete pipe system according to the present invention will be apparent to those skilled in the art. Various aspects of the invention have been described above by way of illustration, and the specific embodiments disclosed are not intended to limit the invention to the particular forms disclosed. The particular implementation of the cast-in-place concrete pipe system may vary depending upon the particular context or application. By way of example, and not limitation, the cast-in-place concrete pipe system described in the foregoing was principally directed to the casting of concrete pipe. However, similar techniques may instead be applied to other construction methods which implementations of the present invention are contemplated as within the scope of the present invention. Such possibilities include, but are not limited to, building or other fixed structure or concrete pipe construction. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Although specific features of the cast-in-place concrete pipe system are shown in some drawings and not others, persons skilled in the art will understand that this is for convenience. Each feature may be combined with any or all of the other features in accordance with the invention. The words “including,” “comprising,” “having,” and “with” as used herein are to be interpreted broadly and comprehensively, and are not limited to any physical interconnection. Claim elements and steps herein may have been numbered and/or lettered solely as an aid in readability and understanding. Any such numbering and lettering in itself is not intended to and should not be taken to indicate the ordering of elements and/or steps in the claims to be added at a later date.

Any amendment presented during the prosecution of the application for this patent is not a disclaimer of any claim element presented in the description or claims to be filed. Persons skilled in the art cannot reasonably be expected to draft a claim that would literally encompass each and every equivalent.

What is claimed is:

1. A cast-in-place concrete pipe system comprising:
a. at least one outer barrel;
b. at least one inner barrel;
c. at least one joint dowel;
d. at least one reinforcement wall separator ring;
e. at least one coupling ring;
f. at least one crown fill port;
g. one or more barrel support stands; and
h. a concrete mixture that is poured into the said at least one fill port and between the outer and inner barrels.

2. The cast-in-place concrete pipe system of claim 1 wherein the at least one outer barrel is connected to the at least one inner barrel by the at least one reinforcement wall separator ring which is welded to said outer barrel and said inner barrel.

3. The cast-in-place concrete pipe system of claim 1 wherein the at least one outer barrel, the at least one inner barrel and the at least one reinforcement wall separator ring connect in such a manner so as to have apertures for the concrete mixture to form a contiguous structure.

4. The cast-in-place concrete pipe system of claim 1 wherein the at least one outer barrel, the at least one inner barrel, the at least one reinforcement wall separator, the at least one coupling ring, and the one or more stabilizing fins are made of a plastic such as High Density Polyethylene (HDPE).

5. The cast-in-place concrete pipe system of claim 1 wherein the at least one dowel is made of a high tensile strength material such as steel or carbon fiber.

6. The cast-in-place concrete pipe system of claim 1 wherein the at least one joint dowel is used to create a reinforcement cage.

7. The cast-in-place concrete pipe system of claim 5 wherein the at least joint dowel creates a helical shaped reinforcement cage.

8. The cast-in-place concrete pipe system of claim 5 wherein the at least one joint dowel creates a cylindrical shaped reinforcement cage.

9. The cast-in-place concrete pipe system of claim 1 wherein the at least one reinforcement wall separator connects and evenly separates the at least one outer barrel to the at least one inner barrel and the at least one joint dowel threads through the at least one reinforcement wall separator so as to create a fixed reinforcement cage between the at least one outer barrel and the at least one inner barrel.

10. The cast-in-place concrete pipe system of claim 1 wherein the at least one joint dowel threads through the at least one reinforcement wall separator and is supported by one or more bar support saddles.

11. The cast-in-place concrete pipe system of claim 1 wherein the at least one coupling ring, the at least one reinforcement wall separator, and the at least one reinforcement dowel can be configured to couple with the at least one outer barrel and the at least one inner barrel of other cast-in-place pipe system components.

12. The cast-in-place concrete pipe system of claim 1 wherein the components of the said cast-in-place concrete pipe system are configurable to couple with existing manhole components, cast-in-place manhole components, existing plastic pipe systems and/or existing concrete pipe systems.

13. A cast-in-place concrete pipe system comprising:
a. at least one plastic outer barrel;
b. at least one plastic inner barrel;
c. at least one steel reinforcement cage;
d. at least one reinforcement wall separator ring;
e. at least one coupling ring;
f. at least one fill port which runs along the uppermost portion of the said outer barrel;
g. one or more barrel support stands; and
h. a concrete mixture that is poured into the said fill port and between the outer and inner barrels.

14. The cast-in-place concrete pipe system of claim 13 wherein the at least one steel reinforcement cage has one or more reinforcement wall separators which connects the at least one outer barrel to the at least one inner barrel and the at least one reinforcement cage threads through the at least one reinforcement wall separator so as to create a fixed reinforcement cage between the at least one outer barrel and the at least one inner barrel.

15. The cast-in-place concrete pipe system of claim 13 wherein the at least one steel reinforcement cage is cylindrically shaped.

16. The cast-in-place concrete pipe system of claim 13 wherein the at least one outer barrel is connected to the at least one inner barrel by the at least one reinforcement wall separator which is spaced apart and welded to said outer barrel and said inner barrel.

17. The cast-in-place concrete pipe system of claim 13 wherein the at least one outer barrel, the at least one inner barrel and the at least one reinforcement wall separator ring connect in such a manner so as to have apertures for the concrete mixture to form a contiguous structure.

18. The cast-in-place concrete pipe system of claim 1 wherein the at least one coupling ring, the at least one reinforcement wall separator, and the at least one reinforcement dowel can be configured to couple with the at least one outer barrel and the at least one inner barrel of other cast-in-place pipe system components.

19. The cast-in-place concrete pipe system of claim 13 wherein the components of the said cast-in-place concrete pipe system are configurable to couple with existing manhole components, cast-in-place manhole components, existing plastic pipe systems and/or existing concrete pipe systems.

20. A method of producing cast-in-place concrete pipe system consisting of at least one outer barrel, at least one inner barrel, at least one reinforcement cage, at least one outer coupler, at least one inner coupler, at least one fill port, one or more stabilizing fins, and a concrete mixture that is poured into the fill port and between the outer and inner barrels; said method comprising the steps of:
a. submitting drawings to a central facility;
b. preparing the plastic forms;
c. preparing the reinforcement cage;
d. transporting the plastic forms and reinforcement cage to a construction site;
e. assembling and configuring the plastic forms;
f. placing the plastic forms in an excavated site;
g. fitting and connecting couplers;
h. pouring a concrete mixture into the plastic forms;
i. allowing the concrete mixture to cure; and
j. burying the filled forms.
